(19) United States
(12) Patent Application Publication
(10) Pub. No.: US 2007/0160902 A1
(43) Pub. Date: Jul. 12, 2007

(54) Alkaline storage battery

(75) Inventors: Hideki Ando, Toyohashi-shi (JP); Hiroyuki Sakamoto, Toyohashi-shi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Aichi-ken (JP)

(21) Appl. No.: 10/588,721

(22) PCT Filed: Mar. 28, 2005
(86) PCT No.: PCT/JP05/06535

§ 371 Date: Aug. 8, 2006

(30) Foreign Application Priority Data
Mar. 29, 2004 (JP) 2004-096655

(51) Int. Cl. H01M 2/18; H01M 2/16

(52) U.S. Cl. 429/144; 429/254; 429/250

(57) ABSTRACT

To present an alkaline storage battery capable of maintaining a favorable self-discharge characteristic for a long period. An alkaline storage battery 10 of the invention comprises a positive electrode 12b, a negative electrode 12c, a separator 12d, and an alkaline electrolyte. The separator 12d is composed of a nonwoven fabric made of a first papermaking web layer 12f and a second papermaking web layer 12g in laminated form, and satisfies the relation of 8.8≦A×B×C≦15.2, where A is the area density (g/m2), B is the specific surface area (m2/g), and C is the thickness (mm).

### TECHNICAL FIELD

The invention relates to an alkaline storage battery containing an alkaline electrolyte.

### BACKGROUND ART

Recently, an alkaline storage battery is highly noticed as a power source for portable devices and mobile devices, and a power source for electric vehicles and hybrid vehicles. Various alkaline storage batteries have been proposed, and in particular, among others, a nickel-metal hydride battery comprising a positive electrode made of active material mainly composed of nickel hydroxide, a negative electrode mainly composed of hydrogen storage alloy, and an alkaline electrolyte containing potassium hydroxide, etc. is used and spread widely as a secondary battery high in energy density and excellent in reliability.

In the nickel-metal hydride battery, hitherto, the problem of drop (worsening) of self-discharge characteristic by repetition of charge and discharge has been known. Lately, by contrast, a nickel-metal hydride battery excellent in self-discharge characteristic even after repetition of charge and discharge has been developed (see, for example, patent document 1).

Patent document 1: Jpn. unexamined patent publication No. 2001-313066.

Patent document 1 indicates the problem of deposition of metal ions eluted from the positive electrode and negative electrode on the separator to form a continuous conductive path between the positive electrode and negative electrode by the conductive deposit. That is, the conductive path formed between the both electrodes is indicated as a factor of lowering of self-discharge characteristic. More specifically, when the amount of electrolyte held on the separator is decreased (liquid depletion), it is indicated that metal ions eluted in the electrolyte are more likely to deposit on the separator. In patent document 1, accordingly, it is devised to avoid liquid depletion of electrolyte held on the separator if charge and discharge are repeated, by keeping the amount of electrolyte held on the separator at 15 mg/cm² or more in the battery assembling process. Thus, by preventing liquid depletion of the separator, deposition of metal ions eluted from the positive electrode and the negative electrode on the separator is suppressed, and thereby the self-discharge characteristic is improved.

Patent document 1 further discloses the improvement of self-discharge characteristic by defining the specific surface area of the separator in a range of 0.60 m²/g to 0.90 m²/g, and the area density in a range of 60 g/m² to 85 g/m². More specifically, in patent document 1, by charging for 30 minutes at 13 A (2 C), and discharging at 13 A (2 C) until the battery voltage becomes 1 V, and after repeating this charging and discharging operation by 200 cycles, the self-discharge characteristic of the battery is evaluated. That is, the battery of patent document 1 maintains a favorable self-discharge characteristic after repetition of 200 cycles of charge and discharge.

### DISCLOSURE OF THE INVENTION

### Problems to Be Solved By the Invention

However, nowadays, there is a strong demand for a longer battery life in nickel-metal hydride battery and other alkaline storage battery (in particular, when used as power source for an electric vehicle or a hybrid vehicle, and the like). By contrast, in the battery of patent document 1, in the case where the self-discharge characteristic is evaluated after repetition of 1000 cycles of charge and discharge in the same condition, the self-discharge characteristic is not always satisfactory. That is, in the battery of patent document 1, after charging and discharging for a long period, a favorable self-discharge characteristic cannot be always maintained.

The invention is conceived in such present situation, and it is hence an object thereof to present an alkaline storage battery capable of maintaining a favorable self-discharge characteristic for a long period.

### Means for Solving the Problems

The solving means is an alkaline storage battery having a positive electrode, a negative electrode, a separator, and an alkaline electrolyte, wherein the separator comprises: a nonwoven fabric made of a plurality of papermaking web layers arranged in laminated form, and the separator satisfies the relation of 8.8≦A×B×C≦15.2, where A is an area density (g/m²), B is a specific surface area (m²/g), and C is a thickness (mm).

In the alkaline storage battery of the invention, the separator is made of a nonwoven fabric made of a plurality of papermaking web layers in laminated form. The alkaline storage battery using such separator made of the nonwoven fabric made of the laminated papermaking web layers is superior in self-discharge characteristic to the battery using the separator made of a nonwoven fabric of a single layer. This is conceivably because the use of the nonwoven fabric made of the laminated papermaking web layers increases discontinuous surfaces between the papermaking web layers, so that conductive paths coupling between both electrodes are less likely to be formed.

Further, in the alkaline storage battery of the invention, the separator satisfies the relation of 8.8≦A×B×C≦15.2, where A is the area density (g/m²), B is the specific surface area (m²/g), and C is the thickness (mm). The inventor supposed that conductive paths coupling between both electrodes would be less likely to be formed by extending the length of path between the positive electrode and the negative electrode formed along the fibers of the separator (hereinafter called inter-electrode path). As a result of investigation by varying three elements of the separator, that is, area density A (g/m²), specific surface area B (m²/g), and thickness C (mm), it is found that the self-discharge characteristic is improved as the product of A×B×C becomes larger. More specifically, by using the separator satisfying the relation of A×B×C≧8.8, the self-discharge characteristic of the alkaline storage battery can be improved. This is conceivably because, when the relation “A×B×C≧8.8” is satisfied, a sufficient inter-electrode path can be assured, and formation of conductive path coupling between both electrodes can be suppressed.

Therefore, in the alkaline storage battery of the invention, conductive path coupling between both electrodes is hardly formed, and a favorable self-discharge characteristic can be maintained for a long period.

As described above, to improve the self-discharge characteristic, the value of “A×B×C” should be as large as possible. But if the value of “A×B×C” is too large, the fiber density of the separator becomes excessive (gaps are decreased), and the separator permeability is lowered, and the internal pressure of the alkaline storage battery may be raised. In contrast thereto, the alkaline storage battery of the invention uses the separator satisfying the relation of A×B×C≦15.2, and lowering of permeability of the separator is suppressed, and hence elevation of the internal pressure of the alkaline storage battery can be also suppressed.

The papermaking web layer is an assembly of fibers made from slurry by mesh, and it is a sheet of one layer. The nonwoven fabric of the separator of the invention may be either wet type nonwoven fabric or dry type nonwoven fabric.

The alkaline storage battery of the invention includes, for example, a nickel-cadmium battery, a nickel-hydrogen battery, and a nickel-zinc battery and the like, and it is applied favorably in an electric vehicle and a hybrid vehicle in particular.

Further, in the alkaline storage battery, the nonwoven fabric of the separator preferably includes plural papermaking web layers mutually different at least in any one of the area density, specific surface area, the thickness, and the sulfonation degree.

In the alkaline storage battery of the invention, the nonwoven fabric of the separator has plural papermaking web layers mutually different at least in any one of the area density, the specific surface area, the thickness, and the sulfonation degree. Since the separator (nonwoven fabric) is composed of plural papermaking web layers different in properties, the characteristic of the alkaline storage battery can be improved.

For example, if more conductive deposit deposits from the negative electrode side than from the positive electrode side, of the nonwoven fabric of the separator, by increasing the area density of the papermaking web layer of the negative electrode side as compared with the papermaking web layer of the positive electrode side, formation of the conductive path can be suppressed more efficiently. Thus, in one separator, selective increasing of the area density of the papermaking web layer can suppress elevation of the fiber density of the entire separator more effectively as compared with the case of increasing of the area density of all the papermaking web layers. As a result, lowering of the air permeability of the separator can be suppressed, and elevation of the internal pressure of the alkaline storage battery can be suppressed.

In the papermaking web layers for composing one separator (nonwoven fabric), when the sulfonation degree (“the number of S atoms contained in fiber”/“the number of C atoms contained in fiber”) is varied, permeability can be maintained by the papermaking web layer of small sulfonation degree while keeping the electrolyte in the separator by the papermaking web layer of large sulfonation degree.

In any one of the above-mentioned alkaline storage batteries, an alkaline storage battery preferably includes the electrolyte at the liquid amount determined in a range of 3.0 g or more to 3.5 g or less per theoretical capacity 1 Ah of the positive electrode.

In the alkaline storage battery, by repetition of charge and discharge, the electrolyte is captured in the positive electrode active material crystal lattices or in the electrode space formed by swelling of electrodes, and the electrolyte in the separator may be in shortage. If the electrolyte in the separator is insufficient (liquid depletion), metal ions eluted in the electrolyte are more likely to deposit on the separator, and the conductive path for coupling between the both electrodes may be formed. By contrast, in the alkaline storage battery of the invention, the liquid amount of the electrolyte per theoretical capacity 1 Ah of the positive electrode is 3.0 g or more. Hence, liquid depletion of the separator can be prevented, and the self-discharge characteristic can be improved.

The larger the volume of the electrolyte, the more the liquid depletion of the separator can be suppressed, but if the volume of the electrolyte is excessive, the air permeability of the separator is lowered, and the internal pressure of the alkaline storage battery may be raised. By contrast, in the alkaline storage battery of the invention, however, since the volume of the electrolyte is controlled at 3.5 g or less per theoretical capacity 1 Ah of the positive electrode, lowering of the permeability of the separator is suppressed, and elevation of the internal pressure of the alkaline storage battery can be suppressed. The theoretical capacity of the positive electrode is a capacity calculated as 289 mAh per 1 g of nickel hydroxide when nickel hydroxide is used as a positive electrode active material.

In any one of the above-mentioned alkaline storage batteries, the separator of the alkaline storage battery is preferably treated by sulfonation hydrophilic process by sulfuric anhydride.

In the alkaline storage battery of the invention, since the separator is treated by sulfonation hydrophilic process, liquid reservation is improved, and liquid depletion can be prevented. In particular, by sulfonation hydrophilic process using sulfuric anhydride, the inside of fibers for composing separator can be sulfonated, and liquid reservation can be improved. Moreover, sulfonation hydrophilic process by sulfuric anhydride does not require washing of unreacted sulfuric acid after treatment, and it is preferable that the treatment process can be simplified.

Further, in the above-mentioned alkaline storage battery, preferably, the papermaking web layers are composed of at least two types of fibers different in the sulfonation degree.

In the alkaline storage battery of the invention, the papermaking web layers constituting the separator have at least two types of fibers different in the sulfonation degree. That is, since the papermaking web layers are composed of fibers different in the hydrophilic property, the electrolyte can be distributed not uniformly in the papermaking web layers, that is, in the separator. More specifically, by concentrating and keeping the electrolyte in the fibers higher in sulfonation degree, permeation path can be formed around fibers lower in sulfonation degree. Therefore, both liquid reservation and permeability can be improved.

The sulfonation degree is the value calculated by (the number of S atoms contained in fiber)/(the number of C atoms contained in fiber). The sulfonation degree of fibers of the separator can be calculated from the strength ratio of S element measured by using, for example, a publicly known fluorescent X-ray spectrometer.

Further, in either one of the above-mentioned alkaline storage battery, preferably, each of the plurality of papermaking web layers contains split type compound fibers by 30 wt. % or more to 50 wt. % or less.

In the alkaline storage battery of the invention, each of the plurality of papermaking web layers constituting the separator contains split type compound fibers by 30 wt. % or more to 50 wt. % or less. By containing split type compound fibers by 30 wt. % or more, the inter-electrode path can be extended, and formation of conductive path coupling between electrodes can be suppressed. Further, by the content of 50 wt. % or less, the fiber density of the separator is prevented from being excessive. As a result, lowering of permeability of the separator is suppressed, and elevation of the internal pressure of the alkaline storage battery can be suppressed at the same time.

The split type compound fibers are ultrafine fibers obtained by blending and spinning two or more different components, forming into a cloth, and splitting.

Further, in the above-mentioned alkaline storage battery, preferably, the split type compound fibers are composed of at least two types of fibers selected from among polypropylene, polyethylene, polystyrene, polymethyl pentene, and polybutylene.

In the alkaline storage battery of the invention, the split type compound fibers of the papermaking web layers are composed of at least two types of fibers selected from among polypropylene, polyethylene, polystyrene, polymethyl pentene, and polybutylene. The split type compound fibers composed of these fibers are high in melting point, and if heated in the process of manufacturing a nonwoven fabric, the crystalline form of the split type compound fibers is hardly deformed, and the texture can be maintained favorably. Therefore, by containing such split type compound fibers by 30 wt. % or more to 50 wt. % or less, the inter-electrode path can be made sufficiently wide, and formation of the conductive path for coupling between electrodes can be suppressed.

### BRIEF DESCRIPTION OF DRAWINGS

FIG. 1 is a perspective cutaway view of an alkaline storage battery 10 in a first and second embodiments;

FIG. 2 is a sectional view of the alkaline storage battery 10 in the first and second embodiments, take along a line parallel to an upper surface 11c of a cover 11b, showing a structure of an electrode plate group 12;

FIG. 3 is a graph showing the relation of the area density A of a separator 12d and residual SOC after test on the alkaline storage battery 10 in the first embodiment;

FIG. 4 is a graph showing the relation of a specific surface area B of the separator 12d and residual SOC after test on the alkaline storage battery 10 in the first embodiment;

FIG. 5 is a graph showing the relation between (area density A×specific surface area B×thickness C) of the separator 12d and residual SOC, and, between (area density A×specific surface area B×thickness C) and internal pressure, after test on the alkaline storage battery 10 in the first embodiment; and

FIG. 6 is a graph showing the relation of amount of electrolyte per 1 Ah of theoretical capacity of a positive electrode and residual SOC, and, the relation of the amount of electrolyte per 1 Ah of theoretical capacity of a positive electrode and internal pressure.

### EXPLANATION OF REFERENCE SIGNS

10, 20 Alkaline storage battery
11 Case
12 Electrode plate group
12b Positive electrode
12c Negative electrode
12d Separator
12f First papermaking web layer
12g Second papermaking web layer

### BEST MODE FOR CARRYING OUT THE INVENTION

Preferred embodiments of the invention are described below, referring to the accompanying drawings.

### First Embodiment

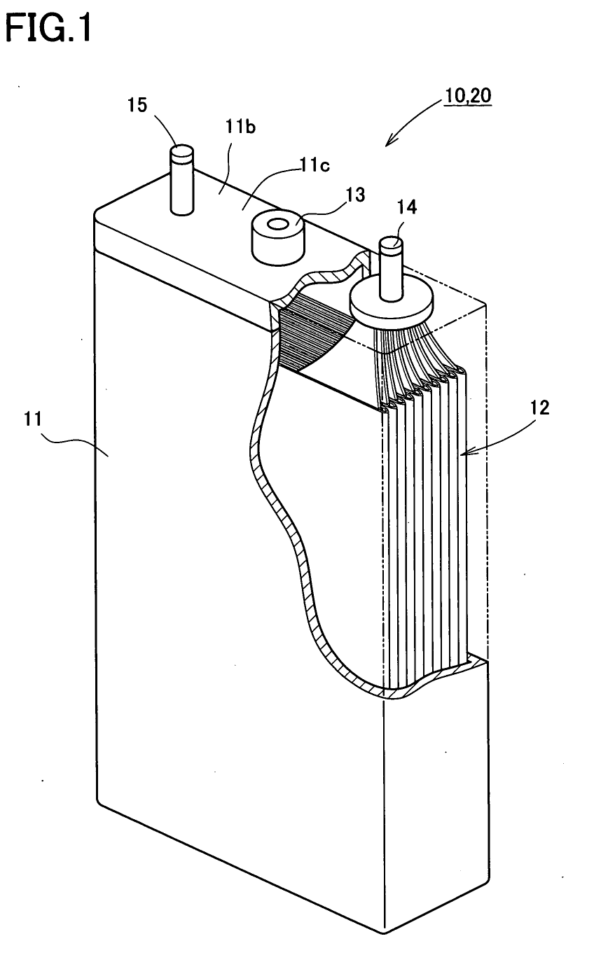

An alkaline storage battery 10 of a first embodiment is a square closed type alkaline storage battery comprising, as shown in FIG. 1, a case 11 having a cover 11b, an electrode plate group 12 and an electrolyte (not shown) contained in the case 11, a safety valve 13 fixed to the cover 11b, a positive electrode terminal 14, and a negative electrode terminal 15.

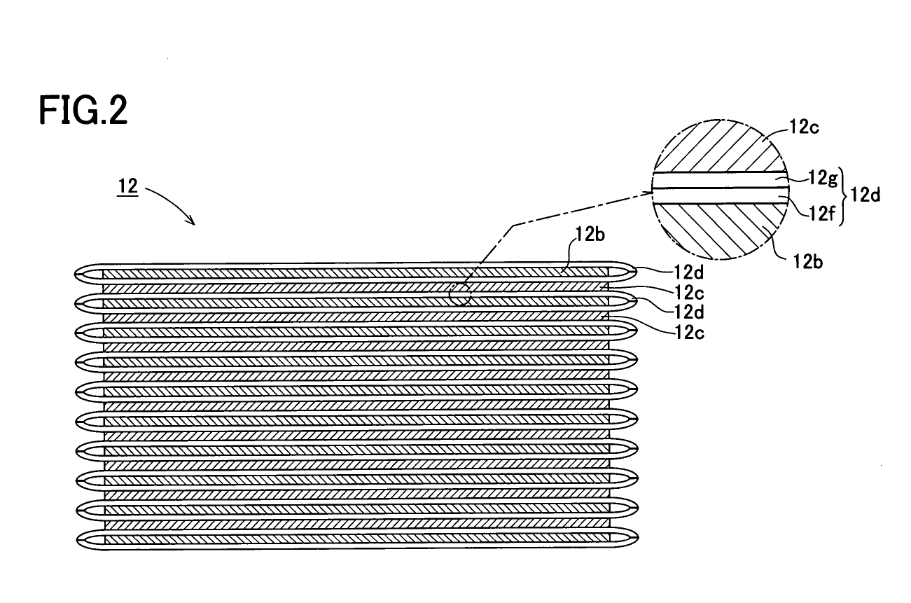

The electrode plate group 12 includes, as shown in FIG. 2, a bag-like separator 12d (hatching omitted), a positive electrode 12b, and a negative electrode 12c. The positive electrode 12b is inserted in the bag-like separator 12d, and the positive electrode 12b inserted in the separator 12d and the negative electrode 12c are laminated alternately.

The positive electrode 12b includes an active material support element, and a positive electrode active material supported on the active material support element. The active material support element also functions as a current collector, and is made of, for example, foamed nickel, other metal porous element, or punching metal. The positive electrode active material is an active material containing, for example, nickel hydroxide and cobalt.

In the first embodiment, the foamed nickel (active material support element) is filled with active material paste containing nickel hydroxide, and it is dried, pressurized and cut, so that the positive electrode 12b is manufactured.

The negative electrode 12c contains hydrogen storage alloy or cadmium hydroxide as negative electrode material. In the first embodiment, paste containing hydrogen storage alloy is applied on a conductive support element, and dried, pressurized and cut, so that the negative electrode 12c is manufactured.

The electrolyte is any electrolyte generally used in an alkaline storage battery. Specifically, for example, an alkaline aqueous solution of specific gravity of 1.2 to 1.4 containing KOH may be used. In the first embodiment, the electrolyte is an alkaline aqueous solution of specific gravity of 1.3 mainly composed of KOH as solute. In the first embodiment, the amount of the electrolyte is 3.2 g per theoretical capacity 1 Ah of the positive electrode. In the first embodiment, the theoretical capacity of the positive electrode is calculated as 289 mAh per 1 g of nickel hydroxide in the positive electrode active material.

The separator 12d can be formed of a nonwoven fabric of hydrophilic synthetic fibers. Specifically, the separator 12d is polyolefin nonwoven fabric or ethylene vinyl alcohol copolymer nonwoven fabric made hydrophilic by sulfonation or application of surface active agent.

In the first embodiment, as shown in the magnified view in FIG. 2, the separator 12d is a nonwoven fabric laminating a first papermaking web layer 12f and a second papermaking web layer 12g. The first papermaking web layer 12f and the second papermaking web layer 12g are identical papermaking web layers, and contain the split type compound fibers composed of polypropylene and polyethylene by 30 wt. %. Further, the separator 12d is treated by sulfonation hydrophilic process, and the sulfonation degree (number of S atoms/number of C atoms) is different between the polypropylene fiber and the polyethylene fiber contained in the first and second papermaking web layers 12f, 12g as described below.

The separator 12d was manufactured in the following procedure. First, split type compound fibers and nonsplit type fibers of polypropylene and polyethylene were mixed at ratio of 3:7 by weight, and dispersed in water so as to be 0.01 to 0.6 mass %, and a slurry is prepared. Then, using a wet paper making machine, first papermaking webs are made from the slurry. The first papermaking webs are heated to produce the first papermaking web layer 12f Similarly, the second papermaking web layer 12g is formed. The first papermaking web layer 12f and the second papermaking web layer 12g are laminated, dewatered, and heated, so that a wet type nonwoven fabric is manufactured. After that, the wet nonwoven fabric is sulfonated by sulfuric anhydride, and the separator 12d was obtained.

The nonwoven fabric composing the separator 12d is composed of fibers of different sulfonation reaction speeds such as polypropylene fibers and polyethylene fibers. Accordingly, the sulfonated separator 12d is composed of plural fibers different in sulfonation degree. Specifically, the sulfonation degree (number of S atoms contained in fiber/number of C atoms contained in fiber) of polypropylene and polyethylene contained in the first and second papermaking web layers 12f, 12g is respectively 3.6×10⁻³ and 1.9×10⁻³. The sulfonation degree was calculated from the strength ratio of S element measured by using a publicly known fluorescent X-ray spectrometer.

In the first embodiment, six types of the separators 12d different in the area density, specific surface area and thickness were manufactured in the method described above (see Table 1). Specifically, six types of the separators 12d are manufactured by varying the area density A (g/m²), specific surface area B (m²/g), and thickness C (mm) as follows: (A, B, C)=(84, 0.42, 0.18), (64, 0.72, 0.19), (55, 1.03, 0.21), (81, 0.74, 0.20), (77, 0.99, 0.20), and (87, 0.88, 0.21). The six separators 12d were formed like bags. Specific surface area of the separator 12d is measured by using BET method (JIS Z 8830) by nitrogen adsorption. Thickness of the separator 12d is calculated from the average of measured values by measuring a total of 16 positions, at 8 positions each in two test pieces 20 cm×20 cm by using a micrometer (JIS B 7502, 0 to 25 mm).

TABLE 1

| | Specific | | | | Internal |
|---|---|---|---|---|---|
| Area density | surface area | Thickness | | Residual | pressure |
| A (g/m²) | B (m²/g) | C (mm) | A × B × C | SOC (%) | (MPa) |
| 84 | 0.42 | 0.18 | 6.4 | 18 | 0.32 |
| 64 | 0.72 | 0.19 | 8.8 | 25 | 0.38 |
| 55 | 1.03 | 0.21 | 11.9 | 28 | 0.40 |
| 81 | 0.74 | 0.20 | 12.0 | 29 | 0.48 |
| 77 | 0.99 | 0.20 | 15.2 | 34 | 0.59 |
| 87 | 0.88 | 0.21 | 16.1 | 34 | 0.85 |

(Fabrication of the Alkaline Storage Battery 10)

From six types of the bag-like separators 12d, one type is selected, the positive electrode 12b is inserted in each of selected plural separators 12d. The plurality of separators 12d having the positive electrode 12b inserted and the plurality of negative electrodes 12c are laminated alternately, and the electrode plate group 12 is formed. Then, the electrode plate group 12 is inserted into the case 11, and an alkaline aqueous solution of specific gravity of 1.3 is poured in. The positive electrode terminal 14 and the positive electrode 12b are connected by lead wire, and the negative electrode terminal 15 and the negative electrode 12c are connected by lead wire. By the cover 11b having a safety valve 13, the case 11 is sealed, and the alkaline storage battery 10 is fabricated.

Using the remaining five types of the separators 12d, five types of the alkaline storage batteries 10 differing only in the separator 12d are manufactured as stated above. In this manner, six types of the alkaline storage batteries 10 differing only in the separator 12d are manufactured. These six types of the alkaline storage batteries 10 are manufactured so as to be 6.5 Ah in battery capacity.

(Self-Discharge Characteristic Evaluation Test)

In six types of the alkaline storage batteries 10, evaluation of each self-discharge characteristic is tested. First, six types of the alkaline storage batteries 10 are charged and discharged for 1000 cycles. One cycle consists of charging for 30 minutes at 2 C (13 A), and discharging until battery voltage becomes 1 V at 2 C (13 A). After the test, each alkaline battery is charged to 60% of SOC (state of charge) at current of 0.6 C (3.9 A), and is let stand in the atmosphere of 45 deg. C. for 1 week. Herein, 1 C=6.5 A, and SOC 100%=6.5 Ah.

Then, after discharging until the battery voltage becomes 1.0 V at 0.3 C (1.95 A), and the residual SOC (%) of each of the alkaline storage battery 10 is measured. In each of the alkaline storage battery 10, by charging for 4 hours at 2 A, a maximum internal pressure (MPa) is measured (called internal pressure hereinafter). Results are shown in TABLE 1.

In the first embodiment, in order to investigate whether favorable self-discharge characteristic is obtained for a long period or not, it must be noted that operation of charge and discharge is repeated for an extremely long period of 1000 cycles.

In the first embodiment, the alkaline storage battery 10 of which residual SOC after test is 25% or more is evaluated as a favorable alkaline storage battery. An alkaline storage battery of which internal pressure is 0.6 MPa or less is evaluated as an alkaline storage battery of favorable internal pressure characteristic. On the basis of such evaluation standard, results in TABLE 1 are discussed, and the alkaline storage battery 10 using the separator 12d of the area density of 84 g/m², specific surface area of 0.42 m²/g, and thickness of 0.18 mm (top line in the table) is lowered in the residual SOC after test of 18%, and the self-discharge characteristic is not favorable.

By contrast, the other five types of the alkaline storage batteries 10 using other separators 12d, the residual SOC after test is 25% or more, and the self-discharge characteristic is favorable. However, in the alkaline storage battery 10 using the separator 12d of area density of 87 g/m², specific surface area of 0.88 m²/g, and thickness of 0.21 mm (bottom line in the table), the internal pressure is elevated to 0.85 MPa, and the internal pressure characteristic is poor.

Noticing three elements of separator, the area density A (g/m²), specific surface area B (m²/g), and thickness C (mm), the relation with self-discharge characteristic (residual SOC after test) is investigated.

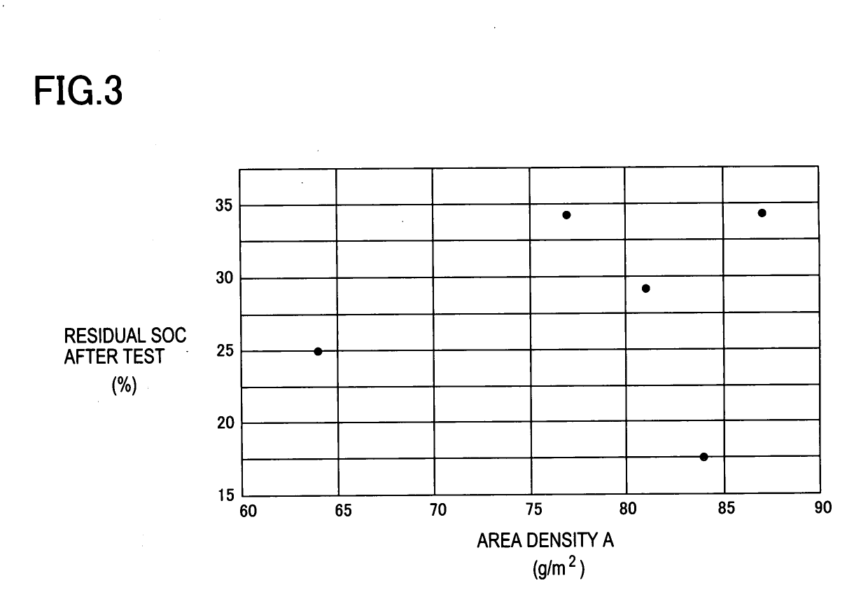

First, the relation of the area density A of separator 12d and residual SOC after test is investigated. FIG. 3 is a graph showing the relation of the area density A of the separator 12d and residual SOC after test on the basis of test results in TABLE 1. As known from FIG. 3, the self-discharge characteristic is not merely improved by increasing the area density of the separator 12d.

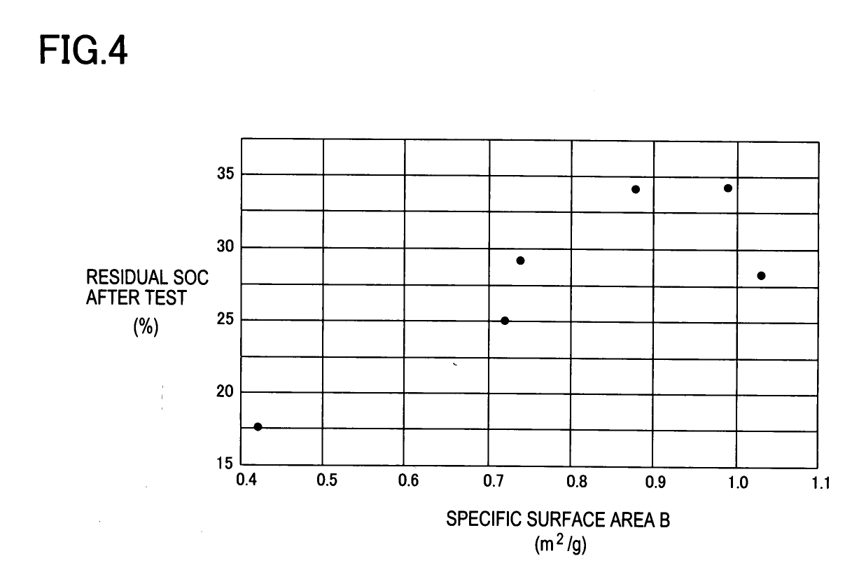

Next, the relation of specific surface area B of the separator 12d and residual SOC after test is investigated. FIG. 4 is a graph showing the relation of specific surface area B of the separator 12d and residual SOC after test on the basis of test results in TABLE 1. As known from FIG. 4, the self-discharge characteristic is not merely improved by increasing the specific surface area of the separator 12d.

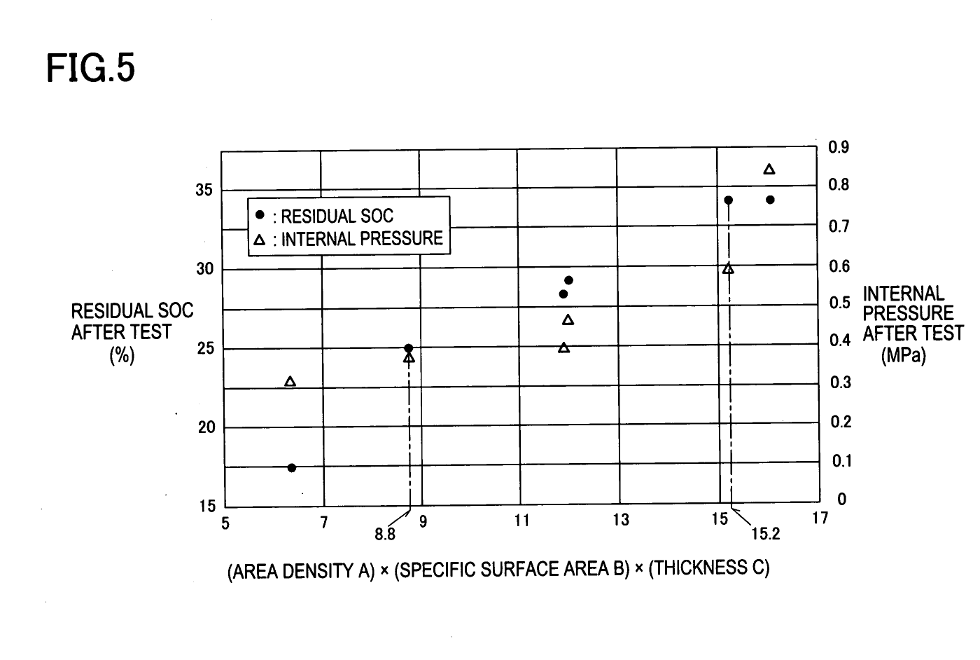

Further, the relation between (area density A×specific surface area B×thickness C) of the separator 12d and residual SOC after test is investigated. FIG. 5 is a graph showing the relation between (area density A×specific surface area B×thickness C) of the separator 12d and residual SOC after test, and between (area density A×specific surface area B×thickness C) and internal pressure, on the basis of the test results in TABLE 1. The relation between (area density A×specific surface area B×thickness C) and residual SOC after test is indicated by a black bullet (●) in FIG. 5. As known from FIG. 5, by increasing the value of (area density A×specific surface area B×thickness C), the self-discharge characteristic is improved. Moreover, when the value of (area density A×specific surface area B×thickness C) is 8.8 or more, a favorable self-discharge characteristic is obtained (residual SOC after test being 25% or more). That is, by defining A×B×C≧8.8, a sufficient inter-electrode path can be obtained sufficiently, and formation of the conductive path for coupling between both electrodes can be suppressed.

On the other hand, the relation between (area density A×specific surface area B×thickness C) and internal pressure is investigated. As indicated by a blank triangle mark (Δ) in FIG. 5, by increasing the value of (area density A×specific surface area B×thickness C), the internal pressure is elevated. As a result, to suppress elevation of internal pressure, the value of (area density A×specific surface area B×thickness C) must be 15.2 or less.

Thus, using the separator satisfying the relation of 8.8≦(area density A×specific surface area B×thickness C)≦15.2, a favorable self-discharge characteristic is maintained for a long period, and the internal pressure characteristic is improved at the same time.

### COMPARATIVE EXAMPLE

A comparative example of alkaline storage battery was manufactured same as in the first embodiment, except that the separator only is different. In the first embodiment, specifically, the separator is a nonwoven fabric laminating the first papermaking web layer 12f and the second papermaking web layer 12g, while in the comparative example, a nonwoven fabric of single layer structure (only first papermaking web layer) is used. In the separator of the comparative example, area density A is 75 g/m², specific surface area B is 0.75 m²/g, and thickness C is 0.2 mm, that is, A×B×C=11.3. This alkaline storage battery of comparative example is tested same as in the first embodiment, and the residual SOC and the internal pressure are evaluated. Results are shown in TABLE 2.

TABLE 2

| | Specific | | | | Internal |
|---|---|---|---|---|---|
| Area density | surface area | Thickness | | Residual | pressure |
| A (g/m²) | B (m²/g) | C (mm) | A × B × C | SOC (%) | (MPa) |
| 75 | 0.75 | 0.20 | 11.3 | 13 | 0.33 |

As described above, in the first embodiment, by using the separator satisfying the relation of 8.8≦(area density A×specific surface area B×thickness C)≦15.2, a favorable self-discharge characteristic is maintained for a long period. In the comparative example, however, as shown in TABLE 2, in spite of using the separator satisfying the relation of A×B×C (specifically A×B×C=11.3), the residual SOC after test is lowered to 13%, and self-discharge characteristic is not favorable. This is considered because a separator of nonwoven fabric of single layer structure is used in the comparative example. That is, the separator of single layer of papermaking web layer seems to be more likely to form a conductive path for coupling between the positive electrode and the negative electrode, as compared with the separator of a plurality of papermaking web layers. Meanwhile, the internal pressure is 0.33 MPa, and the internal pressure characteristic is favorable.

As a result of (the first embodiment and the comparative example), the alkaline storage battery using a separator made of a nonwoven fabric laminating a plurality of papermaking web layers seems to be excellent in self-discharge characteristic as compared with the case of using a nonwoven fabric of single layer. That is, by using a nonwoven fabric laminating a plurality of papermaking web layers, discontinuous surfaces are increased between layers of papermaking web layers, and conductive path coupling between both electrodes seems to be less likely to be formed.

### Second Embodiment

Five types of the alkaline storage batteries 20 are prepared for investigating an appropriate amount (g) of electrolyte per 1 Ah of theoretical capacity of positive electrode. The alkaline storage battery 20 of a second embodiment is same as the structure of the alkaline storage battery 10 in the first embodiment as shown in FIG. 1.

Five types of the alkaline storage batteries 20 in the second embodiment are different only in the injected amount (g) of electrolyte, and identical in all other aspects.

Specifically, in the second embodiment, as shown in TABLE 3, five types of the alkaline storage batteries 20 are manufactured by varying the amount (g) of electrolyte per 1 Ah of theoretical capacity of positive electrode as follows: 2.5 g, 3.0 g, 3.3 g, 3.5 g, and 3.8 g. The five types of the alkaline storage batteries 20 have commonly the same separator 12d of area density A of 70 g/m², specific surface area B of 0.8 m²/g, and thickness C of 0.2 mm, that is, A×B×C=11.2. The five types of the alkaline storage batteries 20 are manufactured to have battery capacity of 6.5 Ah same as in the first embodiment.

TABLE 3

| Amount (g) of electrolyte per 1 Ah of | Internal pressure | Residual |
|---|---|---|
| theoretical capacity of positive electrode | (MPa) | SOC (%) |
| 2.5 | 0.34 | 23 |
| 3.0 | 0.42 | 34 |
| 3.3 | 0.49 | 31 |
| 3.5 | 0.53 | 33 |
| 3.8 | 0.95 | 30 |

(Self-Discharge Characteristic Evaluation Test)

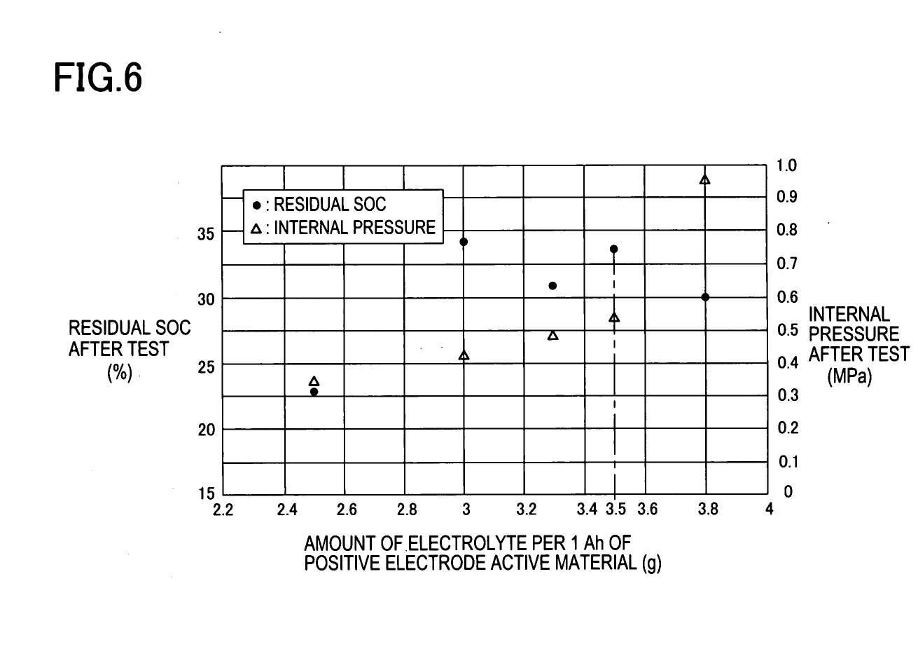

In these five types of the alkaline storage batteries 20, evaluation of each self-discharge characteristic is tested same as in the first embodiment. Then, in these alkaline storage batteries 20, residual SOC (%) and internal pressure (MPa) are measured. Results are shown in TABLE 3. On the basis of test results in TABLE 3, the relation of amount of electrolyte per 1 Ah of theoretical capacity of the positive electrode 12b and residual SOC after test, and the relation of amount of electrolyte per 1 Ah of theoretical capacity of the positive electrode 12b and internal pressure are investigated, and the results are graphically shown in FIG. 6.

In the second embodiment, too, same as in the first embodiment, when the residual SOC after test is 25% or more of the alkaline storage battery 20, the self-discharge characteristic of the alkaline storage battery is evaluated to be favorable. Similarly, the alkaline storage battery 20 having internal pressure of 0.6 MPa or less is evaluated to be an alkaline storage battery excellent in internal pressure characteristic.

On the basis of such an evaluation standard, results shown in TABLE 3 and FIG. 6 are discussed, and four types of the alkaline storage batteries 20 having the amount of electrolyte per 1 Ah of theoretical capacity of the positive electrode of 3.0 g, 3.3 g, 3.5 g, and 3.8 g (second to fifth lines in table) are 25% or more in residual SOC after test, and favorable in self-discharge characteristic.

By contrast, the alkaline storage battery 20 having the amount of electrolyte per 1 Ah of theoretical capacity of positive electrode of 2.5 g (top line in table) is 23% in residual SOC after test, and is not favorable in self-discharge characteristic. This is considered because, at the amount of electrolyte per 1 Ah of theoretical capacity of positive electrode of 2.5 g, the electrolyte is taken into the crystal lattices of positive electrode active material or electrode space formed by swelling of electrodes due to repetition of charge and discharge, and the electrolyte in the separator 12d is in shortage in the separator 12d. That is, because of shortage of electrolyte (liquid depletion) in the separator 12d, metal ions eluted in electrolyte solute are more likely to deposit on the separator 12d, and multiple conductive paths coupling between both electrodes are formed.

Considering from these results, by defining the amount of electrolyte per 1 Ah of theoretical capacity of the positive electrode at 3.0 g or more, a favorable self-discharge characteristic may be maintained for a long period.

Meanwhile, investigating the internal pressure, in four types of the alkaline storage batteries 20 having the amount of electrolyte per 1 Ah of theoretical capacity of positive electrode of 2.5 g, 3.0 g, 3.3 g, and 3.5 g (first to fourth lines in table), the internal pressure is 0.6 MPa or less, and the internal pressure characteristic is favorable. By contrast, in the alkaline storage battery 10 having the amount of electrolyte per 1 Ah of theoretical capacity of positive electrode of 3.8 g (bottom line in table), the internal pressure is elevated to 0.95 MPa, and the internal pressure characteristic is not favorable. This is because the amount of electrolyte per 1 Ah of theoretical capacity of positive electrode is excessive, and the air permeability of the separator 12d is lowered too much.

Hence, by defining the amount of electrolyte per 1 Ah of theoretical capacity of positive electrode at 3.5 g or less, it seems that a favorable internal pressure characteristic can be maintained for a long period.

Accordingly, by defining the amount of electrolyte per 1 Ah of theoretical capacity of positive electrode at 3.0 g or more to 3.5 g or less, a favorable self-discharge characteristic may be maintained for a long period, and the internal pressure characteristic can be improved at the same time.

The invention is thus explained by referring to the first and second embodiments, but the invention is not limited to these embodiments alone, but may be changed and modified in various forms without departing from the true spirit thereof.

For example, in the first and second embodiments, the separator is sulfonated by sulfuric anhydride, but similar effects can be obtained even though sulfonated by fuming sulfuric acid.

In the first and second embodiments, the separator is fabricated by using two types of fibers different in sulfonation degree (specifically, polypropylene and polyethylene), but the fibers for composing the separator are not limited to them alone. For example, the separator may be composed of one type of sulfonated fiber only. Or the separator may be formed of three or more types of fibers different in sulfonation degree.

In the first and second embodiments, the separator is formed of a nonwoven fabric containing split type compound fibers of polypropylene and polyethylene by 30 wt. %, but the types and contents of fibers for composing the split type compound fibers are not limited to these examples. Specifically, split type compound fibers may be composed by selecting at least two types from among polypropylene, polyethylene, polystyrene, polymethyl pentene, and polybutylene. By defining the content of such split type compound fibers in a range of 30 to 50 wt. %, the same effects as in the first and second embodiments can be obtained.

Further, in the first and second embodiments, the separator 12d is formed like a bag, and the positive electrode 12b is put in its inside. However, the shape is not limited, and the separator 12d may be formed like a sheet, and the lamination layer may be formed such that the separator 12d is interposed between the positive electrode 12b and the negative electrode 12c.

In the first and second embodiments, the same papermaking web layers (the first papermaking web layer 12f and the second papermaking web layer 12g) are laminated, and the separator 12d is composed. However, papermaking web layers to be laminated are not limited to identical layers, and different papermaking web layers (for example, different in area density) may be laminated. Preferably, different papermaking web layers may be laminated, and the characteristic of the alkaline storage battery may be enhanced.

Specifically, in the alkaline storage batteries 10, 20 of the first and second embodiments, since more conductive deposits are released from the negative electrode 12c side than from the positive electrode side 12b, by increasing the area density of the second papermaking web layer 12g positioned at the negative electrode 12c side as compared with the first papermaking web layer 12f positioned at the positive electrode 12b side, formation of conductive pass can be suppressed more efficiently. Thus, as for the separator 12d, selective increasing the area density of papermaking web layer (second papermaking web layer 12g) contributes more to suppression of elevation of fiber density of the entire separator 12d as compared with increase of area density of entire papermaking web layers (first papermaking web layer 12f and second papermaking web layer 12g). Accordingly, lowering of permeability of the separator 12d can be suppressed, and elevation of internal pressure of the alkaline storage battery 10 can be suppressed.

In the first and second embodiments, two layers of the first papermaking web layer 12f and the second papermaking web layer 12g are laminated, and the separator 12d is formed. However, the number of papermaking web layers to be laminated is not limited to two layers, but may be plural layers regardless of the number of layers. Rather, the number of papermaking web layers to be laminated is larger, conductive path for coupling between electrodes is less likely to be formed, and it is preferred because the self-discharge characteristic of the alkaline storage battery can be enhanced.

In the first and second embodiments, wet style nonwoven fabrics are used as the separator 12d, but same effects are obtained by using dry style nonwoven fabrics.

1. An alkaline storage battery having a positive electrode, a negative electrode, a separator, and an alkaline electrolyte,
wherein the separator comprises:
a nonwoven fabric made of a plurality of papermaking web layers arranged in laminated form, and
the separator satisfies the relation of 8.8≦A×B×C≦15.2, where A is an area density (g/m2), B is a specific surface area (m2/g), and C is a thickness (mm).

2. The alkaline storage battery according to claim 1,
wherein the nonwoven fabric forming the separator is composed of a plurality of papermaking web layers different in at least any one of the area density, the specific surface area, the thickness, and sulfonation degree.

3. The alkaline storage battery according to claim 1,
wherein the liquid amount of the electrolyte is in a range of 3.0 g or more to 3.5 g or less per 1 Ah of theoretical capacity of the positive electrode.

4. The alkaline storage battery according claim 1,
wherein the separator is sulfonated to be hydrophilic by sulfuric anhydride.

5. The alkaline storage battery according to claim 4,
wherein the papermaking web layers have at least two types of fibers different in sulfonation degree.

6. The alkaline storage battery according to claim 1,
wherein each of the plurality of papermaking web layers contains split type compound fibers by 30 wt. % or more to 50 wt. % or less.

7. The alkaline storage battery according to claim 6,
wherein the split type compound fibers are composed of at least two types of fibers selected from among polypropylene, polyethylene, polystyrene, polymethyl pentene, and polybutylene.
